(19) United States
(12) Patent Application Publication
(10) Pub. No.: US 2026/0141107 A1
(43) Pub. Date: May 21, 2026

(54) DATA STORAGE CONTROL USING VECTOR-BASED DETECTION OF CONFIDENTIAL INFORMATION

(71) Applicant: Dell Products L.P., Round Rock, TX (US)

(72) Inventors: Neha Gandhi, Bangalore (IN); Manikandan Sethuraman, Bangalore (IN); Peniel Charles, Bangalore (IN)

(21) Appl. No.: 18/952,197

(22) Filed: Nov. 19, 2024

(51) Int. Cl. G06F 21/62

(52) U.S. Cl. CPC G06F 21/6245

(57) ABSTRACT

Techniques are provided for data storage control using vector-based detection of confidential information. One method comprises obtaining user content to be evaluated for a presence of confidential information; generating a vector representation of the obtained user content; comparing the vector representation of the obtained user content to (i) a first set of vector representations in a first database and (ii) a second set of vector representations in a second database; determining that the obtained user content comprises confidential information in response to: (i) the comparison of the vector representation of the obtained user content to the first set of vector representations failing to satisfy a first similarity threshold and (ii) the comparison of the vector representation of the obtained user content to the second set of vector representations satisfying a second similarity threshold; and initiating an automated data storage control action based on a result of the determining.

### BACKGROUND

Organizations often find it difficult to prevent a leakage of confidential information through various communication and/or collaboration channels, such as videoconferencing tools, knowledgebases and chat applications. Confidential information may be leaked, for example, due to a lack of awareness that shared content includes confidential information and/or by a malicious user that may share sensitive information with an unauthorized party.

### SUMMARY

Illustrative embodiments of the disclosure provide techniques for data storage control using vector-based detection of confidential information. One method includes obtaining at least a portion of at least one data structure comprising user content to be evaluated for a presence of confidential information; generating a vector representation of the user content based at least in part on the obtained at least the portion of the at least one data structure; comparing the vector representation of the user content to (i) a first set of vector representations in a first database and (ii) a second set of vector representations in a second database; determining that the user content comprises confidential information in response to: (i) the comparison of the vector representation of the user content to the first set of vector representations in the first database failing to satisfy a first similarity threshold and (ii) the comparison of the vector representation of the user content to the second set of vector representations in the second database satisfying a second similarity threshold; and initiating at least one automated data storage control action based at least in part on a result of the determining.

Illustrative embodiments can provide significant advantages relative to conventional techniques. For example, technical problems related to such conventional techniques are mitigated in one or more embodiments by performing one or more data storage control actions based on a determination of whether content comprises confidential information. The determination of whether the content comprises confidential information may compare (i) a vector representation of the content to a first set of vector representations in a first database, such as a published vector database, and (ii) the vector representation of the content to a second set of vector representations in a second database, such as a confidential vector database.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for data storage control using vector-based detection of confidential information in accordance with an illustrative embodiment;

FIG. 2 is a flow diagram illustrating an exemplary implementation of a process for content creation in accordance with an illustrative embodiment;

FIG. 3 is a flow diagram illustrating an exemplary implementation of a content publication process in accordance with an illustrative embodiment;

FIG. 4 is a flow diagram illustrating an exemplary implementation of a process for vector-based confidential information detection in accordance with an illustrative embodiment;

FIG. 5 is a flow diagram illustrating an exemplary implementation of a process for data storage control using vector-based detection of confidential information in accordance with an illustrative embodiment;

FIG. 6 illustrates an exemplary processing platform that may be used to implement at least a portion of one or more embodiments of the disclosure comprising a cloud infrastructure; and

FIG. 7 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for data storage control using vector-based detection of confidential information.

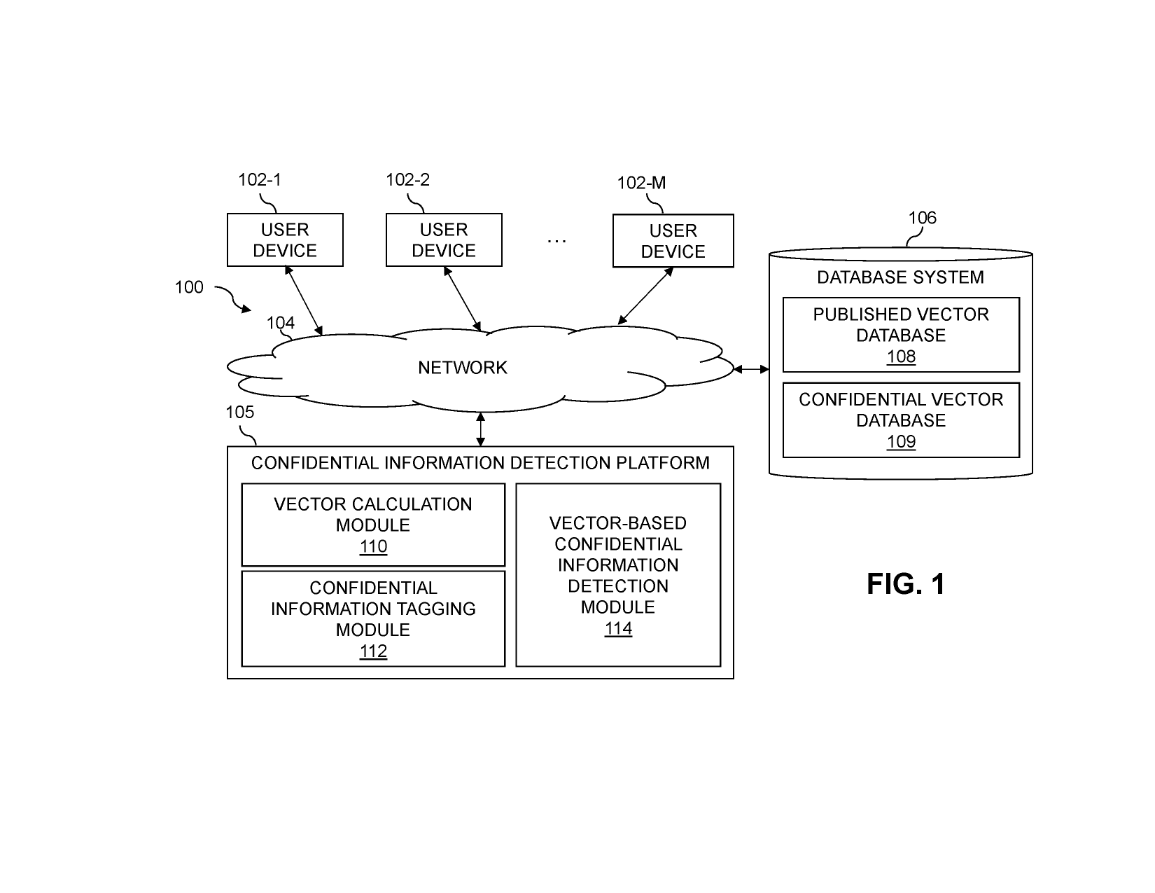

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a vector-based confidential information detection platform 105 and a database system 106.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

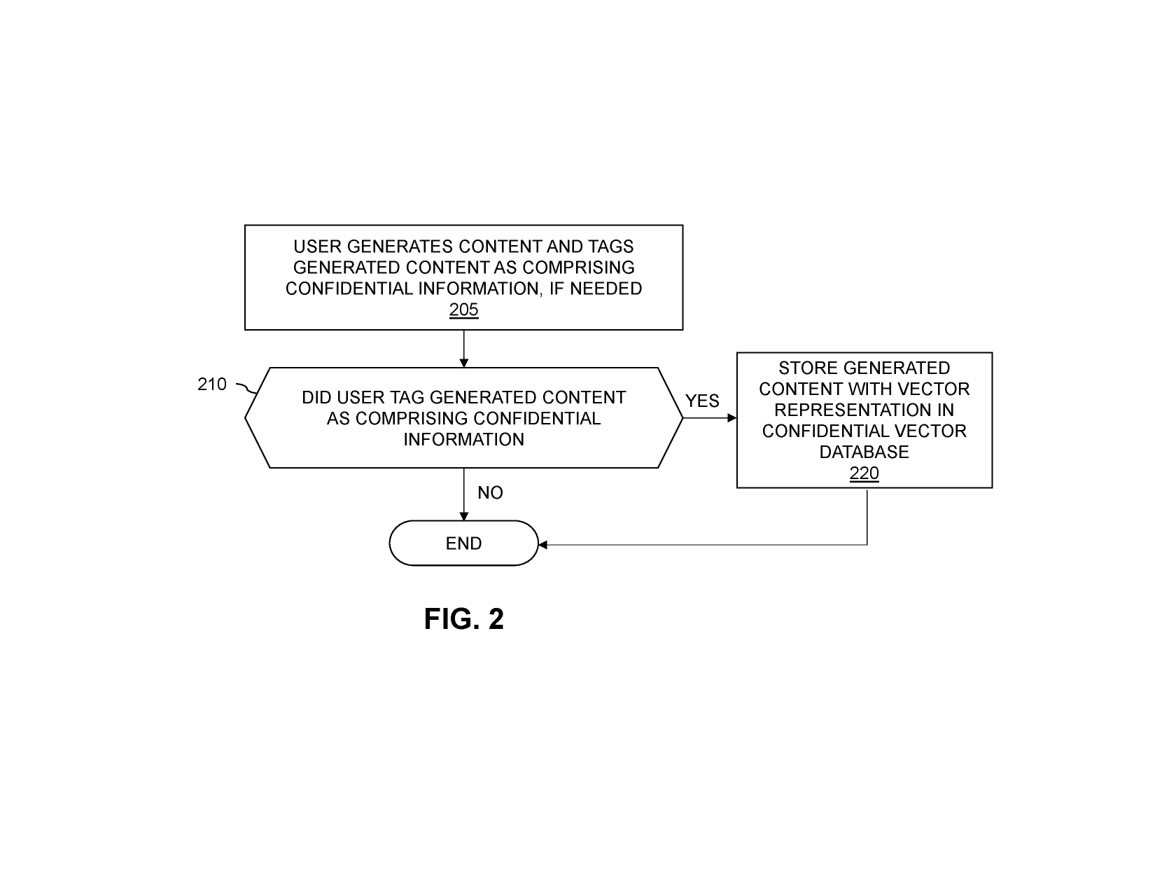

The vector-based confidential information detection platform 105 may comprise a vector calculation module 110, a confidential information tagging module 112 and a vector-based confidential information detection module 114. The vector calculation module 110, in some embodiments, may generate vector representations of content to be protected and/or evaluated using the disclosed vector-based confidential information detection techniques, as discussed further below in conjunction with FIGS. 2 through 4. A vector is a numerical representation of text in LLMs. These vectors capture the meaning and relationships between words, allowing the model to understand context, similarity, and patterns in language. This helps the model understand context and generate relevant responses.

One or more aspects of the disclosure recognize that a vector representation of content allows the presence of confidential information to be detected even if the content is changed or modified, for example, by an LLM, another AI-based tool or otherwise rephrased.

In at least some embodiments, the confidential information tagging module 112 allows a content creator or another user to identify content that comprises confidential information, as discussed further below in conjunction with FIG. 2, for example.

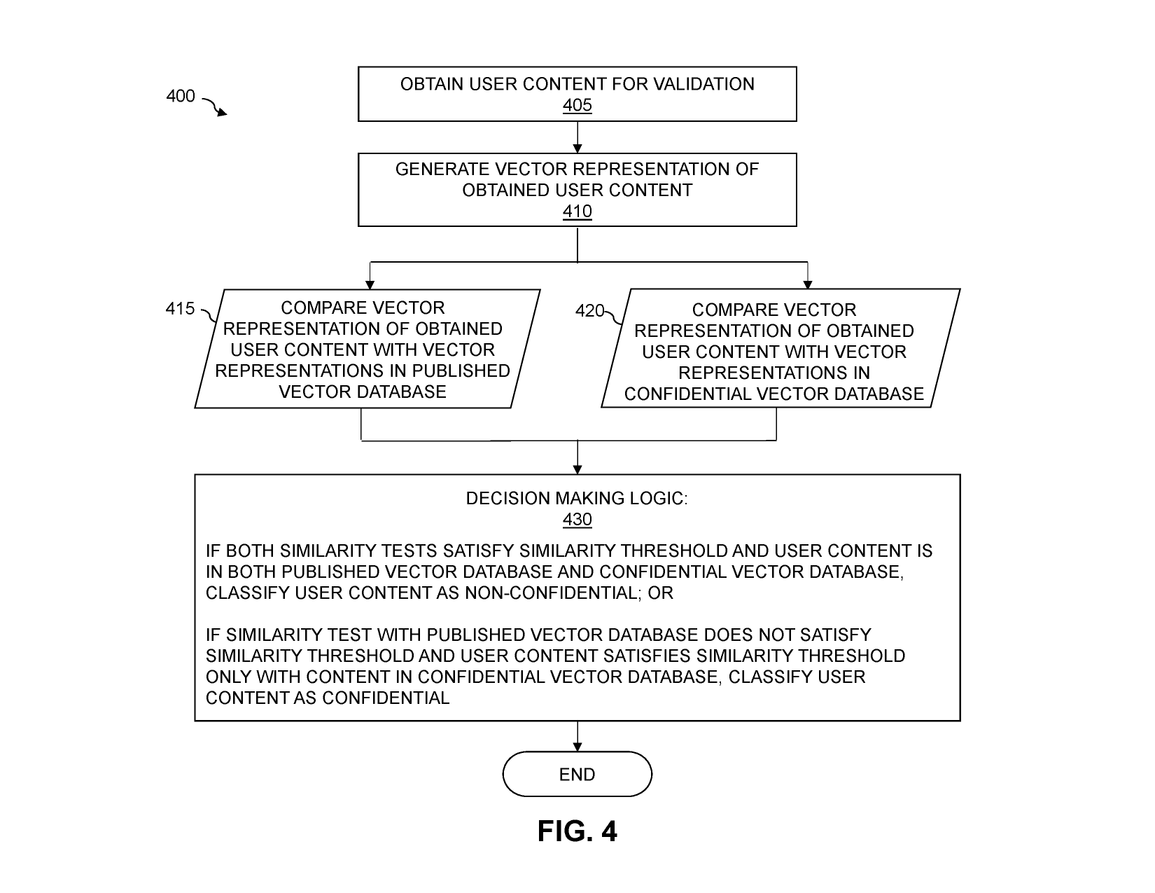

In one or more embodiments, the vector-based confidential information detection module 114 evaluates vector representations of content to be evaluated against stored vector representations to determine if the content to be evaluated comprises confidential information, as discussed further below in conjunction with FIG. 4, for example.

Exemplary processes utilizing elements 110, 112 and/or 114 will be described in more detail with reference to, for example, FIGS. 2 through 5.

It is to be appreciated that this particular arrangement of elements 110, 112 and/or 114 illustrated in the vector-based confidential information detection platform 105 of the FIG. 1 embodiment is presented by way of example only, and alternative arrangements can be used in other embodiments. For example, the functionality associated with the elements 110, 112 and/or 114 in other embodiments can be combined into a single module, or separated across a larger number of modules. As another example, multiple distinct processors can be used to implement different ones of the elements 110, 112 and/or 114 or portions thereof.

At least portions of elements 110, 112 and/or 114 may be implemented at least in part in the form of software that is stored in memory and executed by a processor.

Additionally, the database system 106 may comprise one or more databases, such as a published vector database 108 and/or a confidential vector database 109, as discussed further below in conjunction with FIGS. 2 through 4, for example. The databases 108, 109 may be configured to store data, for example, in tables, in a known manner. While the databases 108, 109 are illustrated in FIG. 1 as comprising distinct databases, at least portions of the databases 108, 109 may be implemented using a single database (e.g., different parts of a single database). Example databases 108, 109, such as depicted in the present embodiment, can be implemented using one or more storage systems associated with the vector-based confidential information detection platform 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the vector-based confidential information detection platform 105 are one or more input-output devices, which illustratively comprise keyboards, displays or other types of input-output devices in any combination. Such input-output devices can be used, for example, to support one or more user interfaces to the vector-based confidential information detection platform 105, as well as to support communication between vector-based confidential information detection platform 105 and other related systems and devices not explicitly shown.

Additionally, the vector-based confidential information detection platform 105 in the FIG. 1 embodiment is assumed to be implemented using at least one processing device. Each such processing device generally comprises at least one processor and an associated memory, and implements one or more functional modules for controlling certain features of the vector-based confidential information detection platform 105.

More particularly, the vector-based confidential information detection platform 105 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the vector-based confidential information detection platform 105 to communicate over the network 104 with the user devices 102, and illustratively comprises one or more conventional transceivers.

It is to be understood that the particular set of elements shown in FIG. 1 for the vector-based confidential information detection platform 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the vector-based confidential information detection platform 105 and at least portions of the database system 106 can be on and/or part of the same processing platform.

FIG. 2 is a flow diagram illustrating an exemplary implementation of a process for content creation in accordance with an illustrative embodiment. In the example of FIG. 2, a user generates content in step 205 and tags the generated content as comprising confidential information, if needed. For example, a content creator may know that the generated content includes confidential information and the content creator declares that the generated content includes confidential information. In one or more embodiments, it is a responsibility of the content creator to ensure that the source material is marked as confidential.

A test is performed in step 210 to determine if the user tagged the generated content as comprising confidential information. If it is determined in step 210 that the user has not tagged the generated content as comprising confidential information, then program control terminates.

If it is determined in step 210 that the user tagged the generated content as comprising confidential information, then the generated content is stored in a confidential vector database, such as the confidential vector database 109 of FIG. 1, in step 220, along with a vector representation of the generated content. The confidential vector database comprises only confidential information, in at least some embodiments. In some embodiments, the functionality of step 220 may be performed periodically or in a batch upon detecting new content, for example with a “confidential” label. At least a portion of the information stored in the confidential vector database comprises only confidential information.

A vector is a numerical representation of text. Vectors are often used, for example, to generate inputs (e.g., queries or system prompts) for large language models (LLMs). Vectors capture the meaning and relationships between words, allowing the LLM, for example, to understand context, similarity, and patterns in language, in order to generate relevant responses.

In one or more embodiments, the vector representation of the generated content may be calculated based on a designated chunk size or for each line of the generated content, for example. In addition, for the same generated content, multiple sets of vectors may be generated, each with a different granularity of the content size. For example, a first set of vectors may be generated using a first chunk size and a second set of vectors may be generated using a second chunk size. Likewise, a first set of vectors may be generated for each line of the generated content and a second set of vectors may be generated for each paragraph of the generated content.

One or more aspects of the disclosure recognize that storing a vector representation with the generated content allows the presence of confidential information to be detected even if the stored content is changed or modified, for example, by an LLM, another artificial intelligence (AI)-based tool or otherwise rephrased.

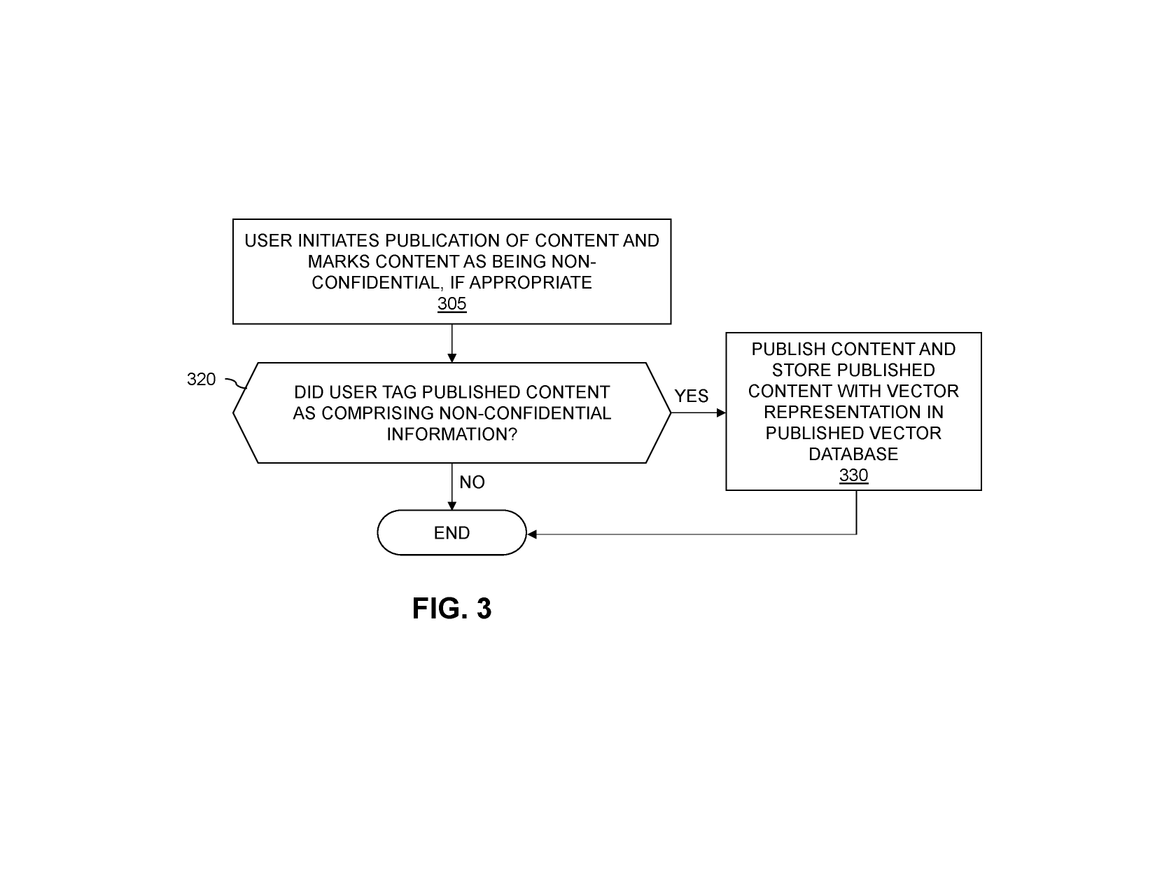

FIG. 3 is a flow diagram illustrating an exemplary implementation of a content publication process in accordance with an illustrative embodiment. In the example of FIG. 3, a user initiates a publication of content in step 305 and marks the content as being non-confidential, if appropriate. In one or more embodiments, it is a responsibility of the document publisher to ensure that the published documents are processed and stored in a published vector database for privacy proofing, as discussed further below.

In one or more embodiments, a test is performed in step 320 to determine if the user tagged the published content as comprising non-confidential information. If it is determined in step 320 that the user tagged the published content as comprising non-confidential information, then the content is published in step 330 and the published content is stored with a vector representation of the published content in the published vector database, such as the published vector database 108 of FIG. 1. The vectors may be generated in a similar manner as discussed above in conjunction with FIG. 2. At least a portion of the information stored in the published vector database comprises only publicly available information.

If, however, it is determined in step 320 that the user has not tagged the published content as comprising non-confidential information, then program control terminates without publishing the content.

FIG. 4 is a flow diagram illustrating an exemplary implementation of a process 400 for vector-based confidential information detection in accordance with an illustrative embodiment. In some embodiments, the process 400 of FIG. 4 may be initiated by a user or performed automatically by a vector-based confidential information detection platform. In the example of FIG. 4, the process 400 obtains user content for validation in step 405. The manner in which the user content is obtained for validation is discussed further below in connection with a number of exemplary use cases.

A vector representation of the obtained user content is generated in step 410, for example, using the vector generation techniques described above. In step 415, the vector representation of the obtained user content is compared with vector representations in the published vector database (e.g., published vector database 108). In step 420, the vector representation of the obtained user content is compared with vector representations in the confidential vector database (e.g., confidential vector database 109). The comparisons performed in steps 415 and 420 may comprise, for example, cosine similarity comparisons that measure the distance between two vectors. As noted above, the vector comparisons employed by the disclosed techniques for vector-based detection of confidential information allow the detection of confidential information even when the confidential information has been rephrased or otherwise modified or before being posted.

One or more aspects of the disclosure recognize that content that has been marked as comprising confidential information may become non-confidential over time (for example, through human error or another inadvertent publication of the confidential information and/or by an intentional publication of the confidential information). Thus, in at least some embodiments, if similar content to the user content being validated is found in the published vector database (e.g., published vector database 108) in step 415 then such content should be treated as non-confidential content.

Following the vector comparisons performed in connection with steps 415 and 420, decision making logic 430 is applied to the vector comparison results. If the similarity tests of steps 415 and 420 both satisfy a designated similarity threshold and the user content being validated is in the published vector database and the confidential vector database, then the user content being validated is classified as comprising non-confidential information. For example, the designated similarity threshold may evaluate whether more than five or six lines are similar between the designated similarity threshold and the vectors in the published vector database and the confidential vector database, or whether more than one paragraph is similar between the designated similarity threshold and the vectors in the published vector database and the confidential vector database.

Likewise, if the similarity test of step 415 does not satisfy a designated similarity threshold and the user content being validated only satisfies a similarity threshold with respect to content in the confidential vector database, then the user content being validated is classified as comprising confidential information. As noted above, in at least some embodiments, if similar content to the user content being validated is found in the published vector database (e.g., published vector database 108) in step 415 then such content should be treated as non-confidential content.

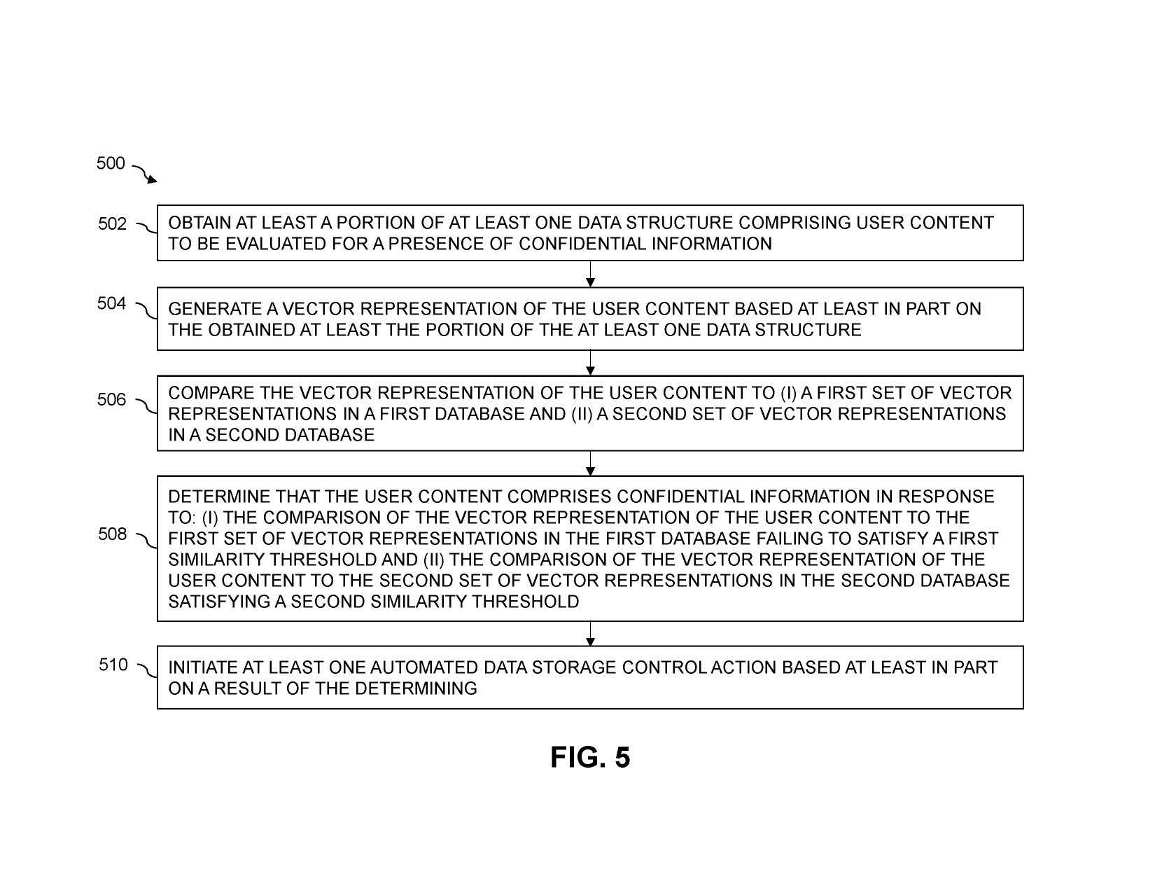

FIG. 5 is a flow diagram illustrating an exemplary implementation of a process 500 for vector-based detection of confidential information in accordance with an illustrative embodiment. In the example of FIG. 5, at least a portion of at least one data structure comprising user content to be evaluated for a presence of confidential information is obtained in step 502.

In step 504, a vector representation of the user content is generated based at least in part on the obtained at least the portion of the at least one data structure. The vector representation of the user content is compared in step 506 to (i) a first set of vector representations in a first database and (ii) a second set of vector representations in a second database.

The user content is determined to comprise confidential information in step 508 in response to: (i) the comparison of the vector representation of the user content to the first set of vector representations in the first database failing to satisfy a first similarity threshold and (ii) the comparison of the vector representation of the user content to the second set of vector representations in the second database satisfying a second similarity threshold.

At least one automated data storage control action is initiated in step 510 based at least in part on a result of the determining.

In at least one embodiment, the first database comprises a published vector database and the second database comprises a confidential vector database. The confidential vector database may be populated with generated content items and corresponding vector representations of the generated content items. The published vector database may be populated with published content items and corresponding vector representations of the published content items.

In some embodiments, the vector representation of the user content comprises a numerical representation of the user content that captures a context of one or more words in the user content. The at least one automated data storage control action may comprise one or more of classifying the user content as comprising confidential information, generating a notification of the confidential information detected in the user content, and causing an action to be performed in another system in response to the confidential information being detected in the user content.

In one or more embodiments, the process 500 further comprises determining that the user content comprises non-confidential information in response to: (i) the comparison of the vector representation of the user content to the first set of vector representations in the first database satisfying the first similarity threshold and (ii) the comparison of the vector representation of the user content to the second set of vector representations in the second database satisfying the second similarity threshold.

The particular processing operations and other network functionality described in conjunction with FIGS. 2 through 5, for example, are presented by way of illustrative example only, and should not be construed as limiting the scope of the disclosure in any way. Alternative embodiments can use other types of processing operations for vector-based detection of confidential information. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

In at least some embodiments, a user interface and the content to be validated may differ according to different use cases, as discussed hereinafter. In one use case, the disclosed techniques for vector-based detection of confidential information are employed to perform privacy proofing, for example, when a support professional validates newly drafted content for a knowledgebase. Thus, the knowledgebase, or a portion thereof, is provided as an input file and a vector representation is generated for the content in the input file. In addition, a cosine similarity comparison is performed between the content in the input file and the content in the published vector database and the confidential vector database. For example, the vectors created from each line and/or block of the content in the input file are compared with corresponding vectors created against content artifacts in the published vector database and the confidential vector database. If the cosine similarity values are within a designated threshold (e.g., 0.80 or above) and similar content exists in both the published vector database and the confidential vector database, then there is an inference that the content in the input file is not matching with the confidential data (e.g., since the subset of the knowledgebase content has a close match with content in the published vector database). Thus, the content may be allowed to be applied to an LLM or another AI tool, for example. Likewise, if the cosine similarity values are not within the designated threshold for the published vector database and the cosine similarity values are within the designated threshold for the confidential vector database, then there is an inference that the content in the input file matches with the confidential data.

In another use case, the disclosed techniques for vector-based detection of confidential information are employed to perform privacy proofing, for example, in a self-validation mode while using communication and collaboration tools. Consider a user that drafts an email with some embedded content or an attached file, but the user is not sure about the confidentiality of the content. Before sending the email to internal or external recipients, the user may activate a privacy proofing option, for example, (e.g., using an external interface or a plugin in mail applications). Thus, the email and/or one or more email attachments, or portions thereof, are provided as an input file and a vector representation is generated for the content in the input file. In addition, a cosine similarity comparison is performed between the content in the input file and the content in the published vector database and the confidential vector database. The results of the cosine similarity comparisons are evaluated in the manner described above for the first use case to determine whether the content comprises confidential information.

In yet another use case, the disclosed techniques for vector-based detection of confidential information are employed to perform privacy proofing, for example, when security professionals are evaluating whether content comprises confidential information. For example, when there are indications or concerns about a potential leak of confidential content (e.g., through public blogs), security professionals can use the disclosed vector-based confidential information detection techniques to assess whether the content in question comprises confidential material. The security professional may activate a privacy proofing option, for example, (e.g., using an appropriate interface). Thus, the content in question may be provided as an input file and a vector representation is generated for the content in the input file. In addition, a cosine similarity comparison is performed between the content in the input file and the content in the published vector database and the confidential vector database. The results of the cosine similarity comparisons are evaluated in the manner described above for the first use case to determine whether the content comprises confidential information.

One or more embodiments of the disclosure provide improved methods, apparatus and computer program products for vector-based detection of confidential information. The foregoing applications and associated embodiments should be considered as illustrative only, and numerous other embodiments can be configured using the techniques disclosed herein, in a wide variety of different applications.

In one or more embodiments, the disclosed techniques for vector-based detection of confidential information may be employed to identify confidential data and to generate an alert, for example, when a subset of shared content comprises confidential information. An interface may be employed where users can evaluate content intended for publication (e.g., to blogs or social media) to determine if the evaluated content comprises confidential content. The vector-based confidential information detection techniques can detect confidential content, even if the content has been rephrased, for example, by users or using AI tools. The vector-based evaluation for confidential information may be performed before such confidential information is posted internally within an organization or publicly to prevent users from leaking confidential data.

It should also be understood that the disclosed techniques for vector-based detection of confidential information, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for vector-based detection of confidential information may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a PaaS, IaaS, STaaS and/or FaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based vector-based confidential information detection engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based vector-based confidential information detection platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

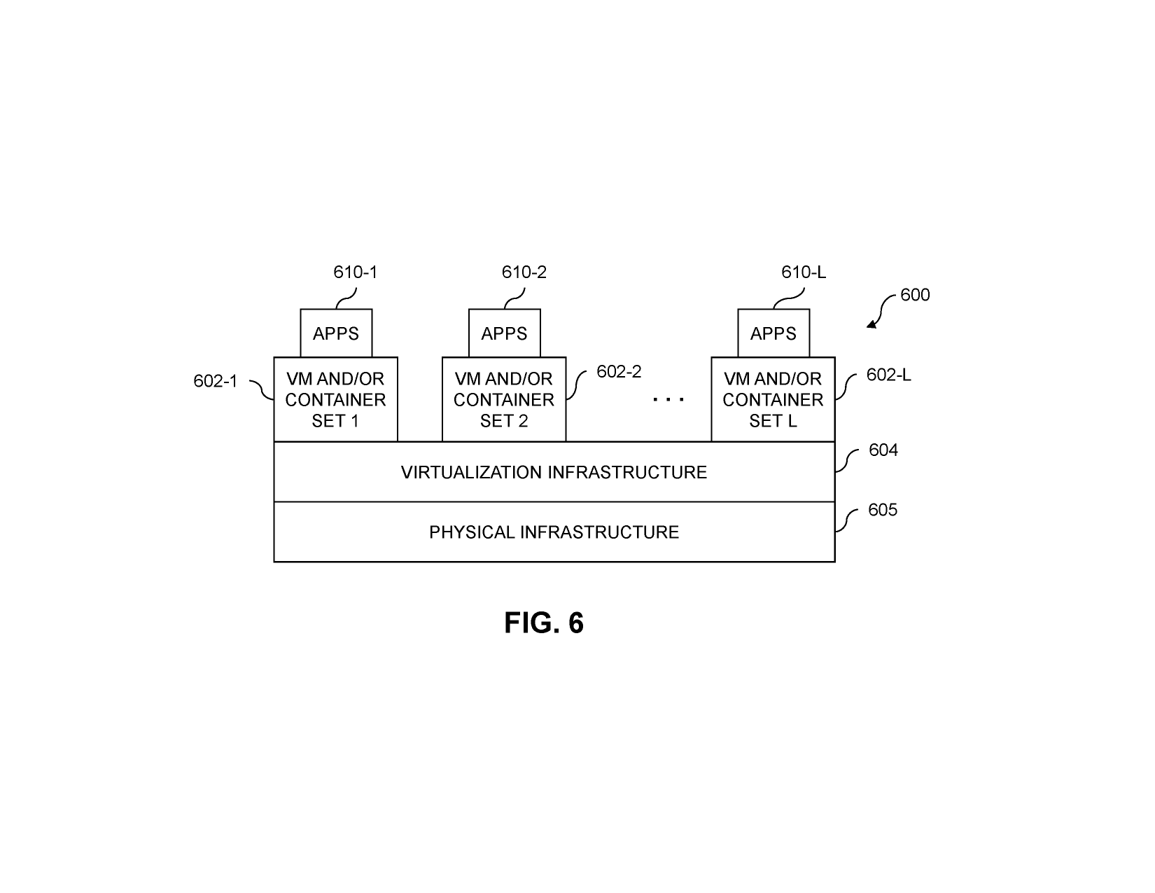

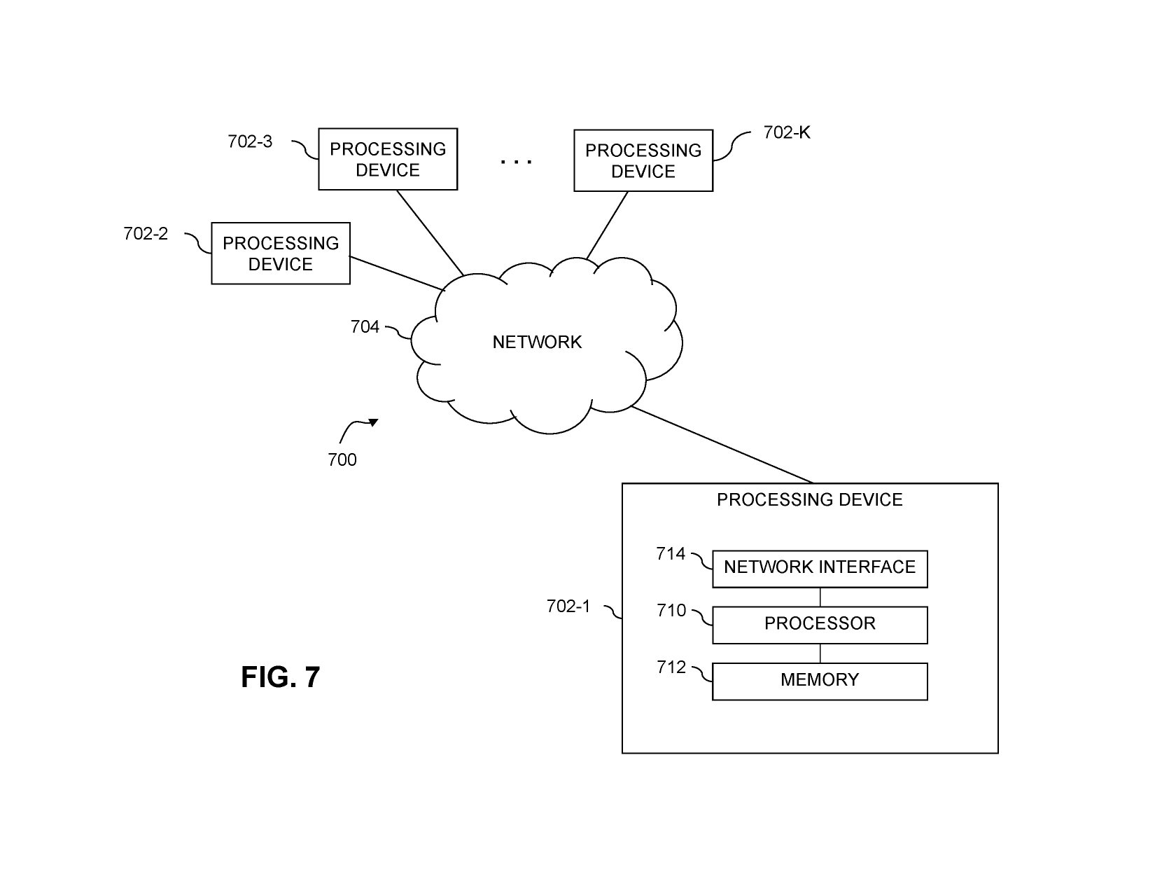

Illustrative embodiments of processing platforms will now be described in greater detail with reference to FIGS. 6 and 7. These platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 60. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. Such implementations can provide chat assistant adaptation functionality of the type described above for one or more processes running on a given one of the VMs. For example, each of the VMs can implement vector-based confidential information detection control logic and associated functionality for generating vectors associated with content to be protected and/or evaluated.

An example of a hypervisor platform that may be used to implement a hypervisor within the virtualization infrastructure 604 is a compute virtualization platform which may have an associated virtual infrastructure management system such as server management software. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such implementations can provide chat assistant adaptation functionality of the type described above for one or more processes running on different ones of the containers. For example, a container host device supporting multiple containers of one or more container sets can implement one or more instances of vector-based confidential information detection control logic and associated functionality for generating vectors associated with content to be protected and/or evaluated.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises at least a portion of the given system and includes a plurality of processing devices, denoted 702-1, 702-2, 702-3, . . . 702-K, which communicate with one another over a network 704. The network 704 may comprise any type of network, such as a WAN, a LAN, a satellite network, a telephone or cable network, a cellular network, a wireless network such as WiFi or WiMAX, or various portions or combinations of these and other types of networks.

The processing device 702-1 in the processing platform 700 comprises a processor 710 coupled to a memory 712. The processor 710 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 712, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIGS. 6 or7, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method, comprising:
obtaining at least a portion of at least one data structure comprising user content to be evaluated for a presence of confidential information;
generating a vector representation of the user content based at least in part on the obtained at least the portion of the at least one data structure;
comparing the vector representation of the user content to (i) a first set of vector representations in a first database and (ii) a second set of vector representations in a second database;
determining that the user content comprises confidential information in response to: (i) the comparison of the vector representation of the user content to the first set of vector representations in the first database failing to satisfy a first similarity threshold and (ii) the comparison of the vector representation of the user content to the second set of vector representations in the second database satisfying a second similarity threshold; and
initiating at least one automated data storage control action based at least in part on a result of the determining;
wherein the method is performed by at least one processing device comprising a processor coupled to a memory.

2. The computer-implemented method of claim 1, wherein the first database comprises a published vector database and the second database comprises a confidential vector database.

3. The computer-implemented method of claim 2, wherein the confidential vector database is populated with generated content items that are designated as confidential generated content items and corresponding vector representations of the generated content items.

4. The computer-implemented method of claim 2, wherein the published vector database is populated with published content items and corresponding vector representations of the published content items.

5. The computer-implemented method of claim 1, wherein the vector representation of the user content comprises a numerical representation of the user content that captures a context of one or more words in the user content.

6. The computer-implemented method of claim 1, further comprising determining that the user content comprises non-confidential information in response to: (i) the comparison of the vector representation of the user content to the first set of vector representations in the first database satisfying the first similarity threshold and (ii) the comparison of the vector representation of the user content to the second set of vector representations in the second database satisfying the second similarity threshold.

7. The computer-implemented method of claim 1, wherein the at least one automated data storage control action comprises one or more of classifying the user content as comprising confidential information, generating a notification related to the confidential information detected in the user content, and causing an action to be performed in another system in response to the confidential information being detected in the user content.

8. An apparatus comprising:
at least one processing device comprising a processor coupled to a memory;
the at least one processing device being configured to implement the following steps:
obtaining at least a portion of at least one data structure comprising user content to be evaluated for a presence of confidential information;
generating a vector representation of the user content based at least in part on the obtained at least the portion of the at least one data structure;
comparing the vector representation of the user content to (i) a first set of vector representations in a first database and (ii) a second set of vector representations in a second database;
determining that the user content comprises confidential information in response to: (i) the comparison of the vector representation of the user content to the first set of vector representations in the first database failing to satisfy a first similarity threshold and (ii) the comparison of the vector representation of the user content to the second set of vector representations in the second database satisfying a second similarity threshold; and
initiating at least one automated data storage control action based at least in part on a result of the determining.

9. The apparatus of claim 8, wherein the first database comprises a published vector database and the second database comprises a confidential vector database.

10. The apparatus of claim 9, wherein the confidential vector database is populated with generated content items that are designated as confidential generated content items and corresponding vector representations of the generated content items.

11. The apparatus of claim 9, wherein the published vector database is populated with published content items and corresponding vector representations of the published content items.

12. The apparatus of claim 8, wherein the vector representation of the user content comprises a numerical representation of the user content that captures a context of one or more words in the user content.

13. The apparatus of claim 8, further comprising determining that the user content comprises non-confidential information in response to: (i) the comparison of the vector representation of the user content to the first set of vector representations in the first database satisfying the first similarity threshold and (ii) the comparison of the vector representation of the user content to the second set of vector representations in the second database satisfying the second similarity threshold.

14. The apparatus of claim 8, wherein the at least one automated data storage control action comprises one or more of classifying the user content as comprising confidential information, generating a notification related to the confidential information detected in the user content, and causing an action to be performed in another system in response to the confidential information being detected in the user content.

15. A non-transitory processor-readable storage medium having stored therein program code of one or more software programs, wherein the program code when executed by at least one processing device causes the at least one processing device to perform the following steps:
obtaining at least a portion of at least one data structure comprising user content to be evaluated for a presence of confidential information;
generating a vector representation of the user content based at least in part on the obtained at least the portion of the at least one data structure;
comparing the vector representation of the user content to (i) a first set of vector representations in a first database and (ii) a second set of vector representations in a second database;
determining that the user content comprises confidential information in response to: (i) the comparison of the vector representation of the user content to the first set of vector representations in the first database failing to satisfy a first similarity threshold and (ii) the comparison of the vector representation of the user content to the second set of vector representations in the second database satisfying a second similarity threshold; and
initiating at least one automated data storage control action based at least in part on a result of the determining.

16. The non-transitory processor-readable storage medium of claim 15, wherein the first database comprises a published vector database and the second database comprises a confidential vector database.

17. The non-transitory processor-readable storage medium of claim 16, wherein the confidential vector database is populated with generated content items that are designated as confidential generated content items and corresponding vector representations of the generated content items.

18. The non-transitory processor-readable storage medium of claim 16, wherein the published vector database is populated with published content items and corresponding vector representations of the published content items.

19. The non-transitory processor-readable storage medium of claim 15, wherein the vector representation of the user content comprises a numerical representation of the user content that captures a context of one or more words in the user content.

20. The non-transitory processor-readable storage medium of claim 15, further comprising determining that the user content comprises non-confidential information in response to: (i) the comparison of the vector representation of the user content to the first set of vector representations in the first database satisfying the first similarity threshold and (ii) the comparison of the vector representation of the user content to the second set of vector representations in the second database satisfying the second similarity threshold.
